(19) United States
(12) Patent Application Publication
(10) Pub. No.: US 2013/0041750 A1
(43) Pub. Date: Feb. 14, 2013

(54) METHOD OF ATTENTION-TARGETING FOR ONLINE ADVERTISEMENT

(71) Applicants: Jun YE, Palo Alto, CA (US); Yu Cao, Saratoga, CA (US); Luoqi Chen, Saratoga, CA (US); Ya Luo, Milpitas, CA (US); Wei Zhuang, Palo Alto, CA (US); Hanying Feng, Fremont, CA (US)

(72) Inventors: Jun YE, Palo Alto, CA (US); Yu Cao, Saratoga, CA (US); Luoqi Chen, Saratoga, CA (US); Ya Luo, Milpitas, CA (US); Wei Zhuang, Palo Alto, CA (US); Hanying Feng, Fremont, CA (US)

(73) Assignee: Founton Technologies, Ltd., Mountain View, CA (US)

(21) Appl. No.: 13/209,256

(22) Filed: Aug. 12, 2011

(51) Int. Cl. G06Q 30/00

(52) U.S. Cl. 705/14.52; 705/14.66

(57) ABSTRACT

The various embodiments described in the present disclosure, in at least one aspect, relate to computer-implemented methods of online advertisement. In one embodiment, a method includes determining an attention score for each of a plurality of ad creatives corresponding to a common ad content based on at least a correlation between each ad creative and a user's subconscious interest. The method further includes selecting an ad creative among the plurality of ad creatives based at least in part on the attention scores, and presenting the ad content with the selected ad creative as an ad impression to the user.

### TECHNICAL FIELD

The present disclosure, in at least one aspect, relates to systems and methods of providing advertising in a network environment, and more particularly to systems and methods of providing online advertising using various attention-targeting approaches.

### BACKGROUND

The increasing popularity of computers and use of communication networks such as the Internet has revolutionized the manner in which advertisers and vendors advertise products and services. Communication networks such as the Internet provide the opportunity for advertisers to reach a wide audience of potential customers. For example, search engines such as Baidu.com, web portal services such as Sina.com, and affiliate programs provide advertisers the opportunity to place ads on their webpages. The ads may comprise hyperlinks (e.g., URLs) to vendors' websites. The effectiveness of an ad campaign may be measured by click-through rate, i.e., the rate online users click on the ad and complete an action. To achieve a click-through, first, an ad should be relevant to the user's interest. For example, when the user is reading a webpage about a certain vacation destination, an ad about travel packages to that vacation destination would be of interest to the user. This is often referred to as interest-targeting advertisement. Second, the ad should be able to grab the user's attention. As the user browses a webpage, the user's central vision is usually focused on the article he or she is reading. The user may only glance at an ad through his or her peripheral vision, i.e., through corners of his or her eyes. Therefore, the ad's design should be such that it can grab the user's attention so as to cause the user to look at the ad more carefully. If an ad fails to grab the user's attention, no mater how relevant the ad's content is to the user's interest, the ad will not be read by the user.

Therefore, a heretofore unaddressed need exists in the art to address at least the aforementioned deficiencies and inadequacies.

### BRIEF SUMMARY

The various embodiments described in the present disclosure, in at least one aspect, relate to computer-implemented methods of online advertisement. In one embodiment, a method includes determining an attention score for each of a plurality of ad creatives corresponding to a common ad content based at least in part on a correlation between each ad creative and a user's subconscious interest. The method further includes selecting an ad creative among the plurality of ad creatives based at least in part on the attention scores, and presenting the ad content with the selected ad creative as an ad impression to the user.

According to various embodiments, an attention score for each ad creative can be determined using at least one of a correlation between each ad creative and the user's subconscious interest, a correlation between each ad creative and the user's demographic information, a correlation between each ad creative and a content of the online session, a correlation between each ad creative and a context layout of the online session, and a correlation between each ad creative and a plurality of ad creatives previously presented to the user.

These and other aspects of the present disclosure will become apparent from the following description of various embodiments taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments and together with the written description, serve to explain various principles of the invention. Wherever possible, the same reference numbers are used throughout the drawings to refer to the same or like elements of an embodiment, and wherein:

FIG. 1 shows an example of a portal webpage including an ad;

FIG. 2 shows a flowchart illustrating a method of online advertisement according to one embodiment; and

FIG. 3 shows a schematic diagram of a network environment that may incorporate various embodiments.

### DETAILED DESCRIPTION

Various embodiments will now be described more fully hereinafter with reference to the accompanying drawings, in which exemplary embodiments are shown. Various aspects may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

### I. Overview

Each time that an instance of an ad is served to a user corresponds to an ad impression. There are at least three elements that are important for an ad impression to achieve a successful click-through in at least some embodiments. These three elements can include, for example: first, the ad should be able to grab a user's attention; second, the content of the ad should be relevant to the user's interest so the user is willing to explore further; and third, the ad should be credible so that the user is willing to take further actions, such as completing a purchase, without worrying about adverse consequences, such as virus infection or identity theft. The click-through-rate (CTR) of an ad may be expressed as,

CTR∝Attention·Interest·Credibility

where Attention, Interest, and Credibility represent the ad's ability to grab the user's attention, the ad's relevance to the user's interest, and the ad's credibility, respectively. The goal of an ad campaign may be to maximize the CTR by maximizing each of Attention, Interest, and Credibility.

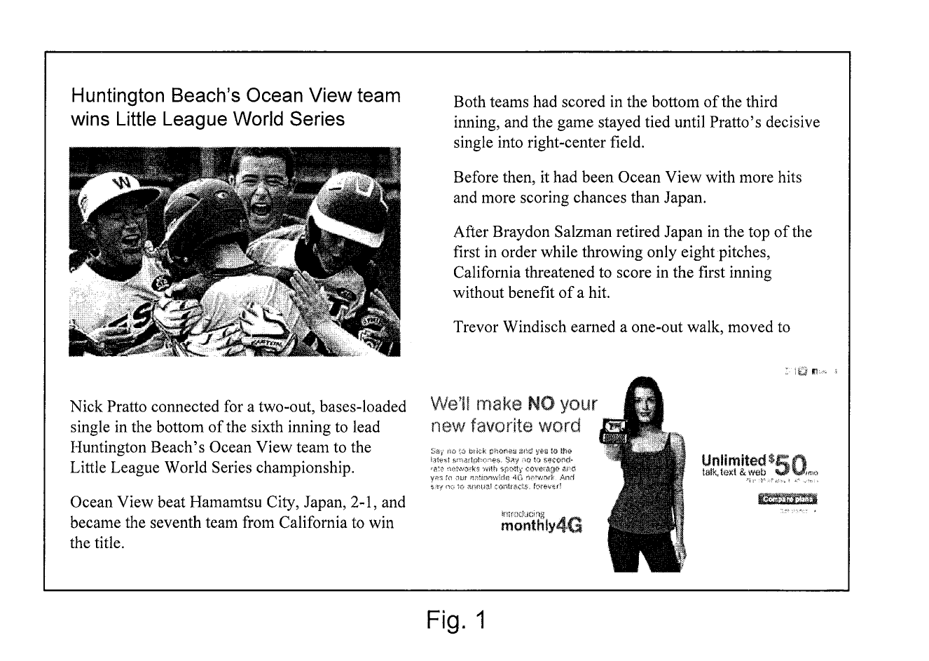

The present disclosure, in one aspect, relates to systems and methods of providing online advertisement using various attention-targeting algorithms. In one embodiment, an exemplary method involves targeting a user's attention using ad creatives. Examples of ad creatives include a picture of a beautiful lady, a picture of a handsome man, a picture of a cute baby, a picture of a beautiful nature scene, a picture of an animal, language symbols, and so on. Different people will be attracted to different ad creatives depending on information such as their demographic profiles, which can include, for example, their age, gender, ethnicity, geographic location, personal factors such as color preferences, and personal interests. As an illustrative example, FIG. 1 shows a portable webpage which includes an ad for mobile phones in its lower right corner. Since this ad has a picture of an attractive lady, it may tend to attract more attention from male users than from female users, or vice versa. Therefore, an ad can beneficially have different designs with different ad creatives targeted toward various users who may all have an interest in the same ad. An ad creative should be at least somewhat relevant to the content of the ad. For example, an ad creative for a baby product ad may include a baby picture. It is noted that the attention-grabbing power of an ad creative may depend on a contrast, such as color contrast, language contrast, and animation vs. static, picture vs. text, between the ad creative and the webpage's context layout. In addition, the attention-grabbing power of an ad creative may also depend on its familiarity or unfamiliarity to a user. It is also noted that it may be preferred not to show the same ad creative to the same user too many times within a certain time span, as he or she may become “fatigued” with the ad creative.

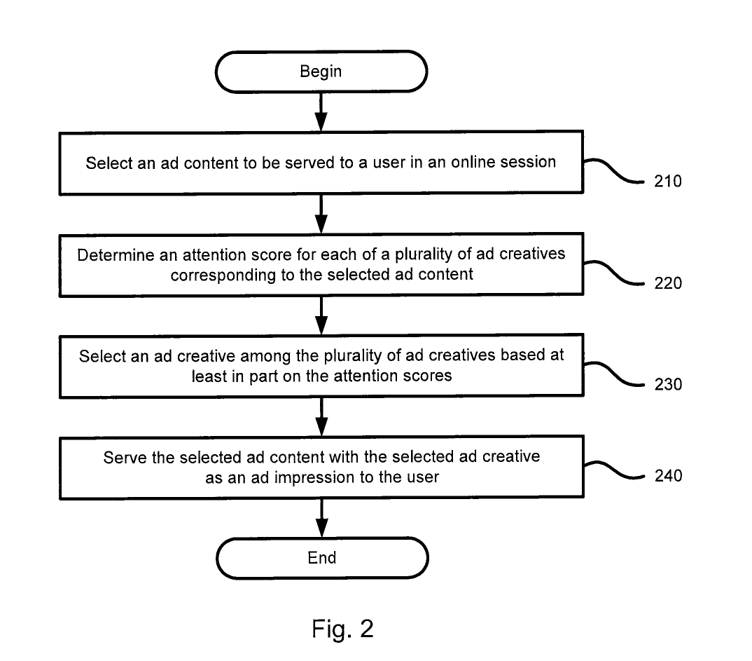

FIG. 2 shows a flowchart illustrating a method of online advertisement according to one embodiment. At step 210, an advertisement system selects an ad content to be served to a user in an online session. There can be a plurality of ad creatives that correspond to the common selected ad content, as may be generated using any appropriate technique known or used in the art for such purposes. At step 220, the system determines an attention score for each of a plurality of ad creatives corresponding to the common ad content. At step 230, the system selects an ad creative among the plurality of ad creatives based at least in part on the attention scores, such as by selecting the highest attention score or lowest attention score, or the score closest to a determined value. At step 240, the system serves the selected ad content with the selected ad creative as an ad impression to the user.

According to various embodiments, an attention score for each ad creative can be determined using at least one of (i) a correlation between each ad creative and the user's subconscious interest, (ii) a correlation between each ad creative and the user's demographic information, (iii) a correlation between each ad creative and a content of the online session, (iv) a correlation between each ad creative and a context layout of the online session, and (v) a correlation between each ad creative and a plurality of ad creatives previously presented to the user.

### II. Subconscious Interest Categories and Various Attention Parameters

### Subconscious Interest Categories

According to one embodiment, an advertisement system defines a set of N subconscious interest (SI) categories, where N is a positive integer. N should be sufficiently large so that most possible human subconscious interests are covered. Some exemplary SI categories include:
Family life. Ad creatives targeting this SI category may include, for example, pictures of couples with or without children, and may be used in ads related to parenting, educational products, family vacations, family restaurants, theme parks, and so on.
Nature. Ad creatives targeting this SI category may include, for example, pictures of mountains, lakes, ocean, or other nature scenes, and may be used in ads related to outdoor gears, vacation packages, hotels, air fares, and so on.
Animal. Ad creatives targeting this SI category may include, for example, pictures of animals, pets, and so on, and may be used in ads related to pet products, wilderness vacation packages, family-attractions, and so on.
Baby. Ad creatives targeting this SI category may include pictures of babies (perhaps from different ethnic groups, such as Asians, Caucasians, African Americans, or Latinos), and may be used in ads related to baby products such as baby food, baby clothing, toys, and so on.
Space and universe. Ad creatives targeting this SI category may include, for example, pictures of space, stars, the earth, and so on, and may be used in ads related to education, science, travel, and so on.
Apparels and accessories. Ad creatives targeting this SI category may include, for example, picture of a beautiful lady or a handsome man, and may be used in ads related to clothing, jewelries, eye-wears, and so on.
Cars. Ad creatives targeting this SI category may include pictures of a car, perhaps with a beautiful lady or a handsome man driving the car.
Major events. Ad creatives targeting this SI category may include texts in large fonts or native language symbols. For example, ads for educational products related to college entrance exams in China may use Chinese characters symbolizing the entrance exam.

Other possible SI categories include food, sports, jobs, and so on. SI categories may be defined through surveying ad experts. In the following, various attention parameters are defined according to various embodiments of the present invention.

### Ad Creative Attention Relevance (AA) Parameters

For each ad creative, the ad creative attention relevance (AA) parameters are defined as an N-dimensional vector,

AA={AAᵢ}, i=1, 2, . . . N.

Each component of the AA vector is a continuous real value, which indicates a relative degree of relevance of the ad creative to a respective SI category. In one embodiment, the component corresponding to the most relevant SI category is assigned a value of one, i.e.,

(AAᵢ)ₘₐₓ=1.

For example, since an ad creative with a baby picture is most relevant to the SI category of “baby,” the AA component corresponding to the “baby” category is assigned a value of one, and any other AA component is assigned a value less than one. A value of zero would mean that the ad creative is irrelevant to that category. The AA vector may be determined by advertisers, ad designers, and/or ad experts. Alternatively, it may be continuously tuned, using user attention vectors of all users who clicked on the ad with the ad creative.

In the case that the SI category set is incomplete, all components of the AA vector may be assigned values less than one, which means that the ad creative does not have a perfect relevance to any of the SI categories. In a possible but unlikely scenario, an ad creative may have a negative relevance to a certain SI category. For example, if an ad creative is designed NOT to be shown to people with certain subconscious interest, the AA component corresponding to that SI category may be assigned a large negative value.

### User Attention (UA) Parameters

For each user, user-attention parameters UA are defined as an N-dimensional vector,

UA={UAᵢ}, i=1, 2, . . . N.

Each component of the UA vector is a continuous value between zero and one, which indicates a relative strength of a user's subconscious interest in that SI category, i.e.,

0≦UA≦1.

For proper normalization, the sum of all components of the UA vector is normalized to one, i.e.,

$${\sum }_{i = 1}^{N} {UA}_{i} = 1.$$

UA vector is a property of each user. The value of the UA vector depends on the user's demographic profile and the user's online behavior. In one embodiment, the UA vector is initially determined from the user's demographic profile and interest information. It is then updated in real time in an IIR fashion as the system captures each behavior instance of the user. Examples of user behavior instances include webpages the user visits, music the user listens to, videos the user watches, ads the user clicks on, purchases the user makes, and so on. Methods of updating the UA vector is described in further detail below according to various embodiments of the present invention.

### Behavior Instance (BI) Parameters

For each user behavior instance, behavior instance (BI) parameters are defined as an N-dimensional vector,

BI={BIᵢ}, i=1, 2, . . . N.

Each component of the BI vector is a continuous value between zero and one, which indicates a relative degree of relevance of the behavior instance to a respective SI category, i.e.,

0≦BIᵢ≦1.

For example, if the user reads a webpage on the topic of baby health, the BI vector for this behavior instance would have a high value in the component corresponding to the “baby” category. For proper normalization, the sum of all components of the BI vector is normalized to one, i.e.,

$${\sum }_{i = 1}^{N} {BI}_{i} = 1.$$

BI vector is a property of each behavior instance of a user, such as a webpage the user reads. BI vectors of web pages (or other web contents) of different topics may be determined through surveying ad experts. The topic of a webpage may be determined through language analysis techniques based on keywords and grammar. For simplicity, the analysis may be performed only on the title of the webpage. In one embodiment, the analysis may be performed in real time. That is, each time a user loads up a webpage, the webpage is analyzed before the ad is served with the webpage. This method may induce too much latency delay in serving the ad, and therefore may degrade user experience. In another embodiment, the analysis may be performed in quasi-real time. That is, when a first user loads up a webpage, the webpage is analyzed and its topic and hence topic-induced BI vector is determined. When other users load up the same webpage at later times, the same BI vector will be used. In yet another embodiment, webpages that the system may serve ads with are proactively crawled, and BI vectors are determined and saved in the system ahead of time.

### Content Attention (CA) Parameters

For each ad space (e.g., a webpage the ad is served with), content attention (CA) parameters are defined as an N-dimensional vector,

CA={CAᵢ}, i=1, 2, . . . N.

Each component of the CA vector is a continuous value between zero and one, which indicates a relative degree of relevance of the ad space to a respective SI category, i.e.,

0≦CAᵢ≦1.

CA vector is a property of each ad space. The value of the CA vector depends on (i) the content or the topic of the webpage surrounding the ad space, and/or (ii) in the case of a portal page with multiple sections, the content of the section within proximity to the ad space. For proper normalization, the sum of all components in the CA vector is normalized to one, i.e.,

$${\sum }_{i = 1}^{N} {CA}_{i} = 1.$$

The CA vector can be regarded as the BI vector for the current webpage with which the ad is served. For example, when a user is viewing a webpage with a specific topic, the CA vector is the same as the BI vector for that webpage. If the ad space is on a portal page that includes several sections on different topics, the relevant content is then the content of the section within proximity to the ad space. For example, a webpage of Sina.com may include several sections on various topics, such as sports, science, entertainment, and so on. If the ad space is in proximity to the sports section, the relevant content of the ad space is then sports, and the CA vector for this ad space is equal to the BI vector for the topic of sports.

### Global (G) Parameters

Global (G) parameters are independent of user, ad space, or ad creative. It describes the bias in attention-grabbing power among different SI categories, since different SI categories may inherently have different attention-grabbing powers. For example, the SI category of “baby” may have a greater attention-grabbing power than the SI category of “car.” Global (G) parameters are defined as an N-dimensional vector,

G={Gᵢ}, i=1, 2, . . . N.

Each component of the G vector is a continuous value between zero and one, i.e.,

0≦Gᵢ≦1

The G vector may be determined through survey of ad experts or through data mining and statistical analysis.

### User Demography (UD) Parameters and the User-Demography Lookup Table

An ad creative's attention-grabbing power may depend on the user's demographic profile, such as gender, age, ethnicity, geographical location, occupation, income range, education level, marital status, children's status, type of browser and operation system he or she uses, time of the day, day of the week, and for mobile applications, type of mobile device and mobile application the user uses, GPS location, and so on. For each user, user demography (UD) parameters are defined as a K-dimensional vector,

UD={UDᵢ}, i=1, 2, . . . K,

where K is a positive integer. Each component of the UD vector corresponds to a respective demographic parameter and has a plurality of discrete states. The plurality of discrete states are mutually exclusive, which means that, for each user, each demographic parameter can be in only one of the plurality of discrete states at any given time. If the information for a demographic parameter is unknown, that parameter is set to a NULL state and does not contribute to the attention score.

Demography attention-targeting operates on the K-dimensional UD vector. For each user, an ad creative's attention-grabbing power depends on a correlation between the ad creative and the user's demographic parameters. Since each demographic parameter has discrete states, the correlation between the ad creative and the user's demographic parameters cannot be expressed as an analytical formula, but a discrete state-to-value lookup table UD_LKP. For each ad creative, its user demography lookup table UD_LKP comprises a K-dimensional vector, of which each component is a lookup table operating on one demographic parameter,

UD_LKP(UD)={UD_LKPᵢ(UDᵢ)}, i=1, 2, . . . K.

The possible lookup values of each component of the UD_LKP vector are values between zero and one, which indicates the ad creative's relative attention-grabbing power with respect to a respective demographic parameter's certain state. For proper normalization, the sum of the maximum values of individual components in the UD_LKP is normalized to one, i.e.,

$${\sum }_{i = 1}^{K} MAX ( {UD\_LKP}_{i} ( {UD}_{i} ) ) = 1 ,$$

unless the ad creative is not targeted toward any demographic parameters, in which case all components of the UD_LKP vector for all states are set to zero, or equivalently, the entire demography targeting step is skipped. User demography lookup tables UD_LKP may be initially determined by advertisers, ad designers, and/or ad experts. Alternatively, they are continuously tuned based on real data.

The following provides an illustrative example of how the user demography lookup table UD_LKP operates according to one embodiment of the present invention. The demographic parameter of “gender” has two discrete states, namely “male” and “female.” If an ad creative is designed to target female users, the lookup value corresponding to “male” would be set to zero, and the lookup value corresponding to “female” would be set to a value between zero and one. If the ad creative is indifferent to the demographic parameter “gender,” the lookup values corresponding to both “male” and “female” would be set to zero. In general, if an ad creative is indifferent to a demographic parameter's state, the lookup values for all states of that demographic parameter should be set to zero. Similarly, the lookup value for any NULL state is set to zero.

If an ad creative is designed not to be shown to any users in a particular state of a demographic parameter, the lookup value corresponding to that state would be set to a large negative value. For example, if an ad creative is designed not to be shown to any male users, the lookup value corresponding to “male” may be set to a large negative value. As another example, if an ad creative is designed to being only shown to users in Shanghai (for example, an ad creative with a Shanghai local symbol), the lookup value for the demographic parameter “location” would be set to a large negative value for user's in all other geographic locations.

### Content Layout (CL) Parameters and the Content-Layout Lookup Table

An ad creative's attention-grabbing power may also depend on the contrast between the ad creative and the webpage with which the ad is served. For example, an ad creative with a greater color contrast with the webpage may have a greater attention-grabbing power than an ad creative that has little or no color contrast with the webpage. As another example, an ad creative with a few Chinese characters in an otherwise English webpage may have a greater attention-grabbing power to users whose native language is Chinese.

For each ad space, context layout (CL) parameters are defined as an L-dimensional vector,

CL={CLᵢ}, i=1, 2, . . . L,

where L is a positive integer. Context layout parameters are property of each ad space. Each component of the CL vector corresponds to a context layout parameter and has a plurality of discrete states. The plurality of discrete states are mutually exclusive, which means that, for each ad space, each context layout parameter can be in only one of the plurality of discrete states. If the information for a context layout parameter is unknown, that parameter is set to a NULL state and does not contribute to the attention score. Examples of context layout parameters include dominant color, language (e.g., English, Chinese), font, brightness, animation vs. static, text vs. picture, and so on. The list of context layout parameters may be determined by ad experts and/or ad designers.

Context layout attention-targeting operates on the L-dimensional CL vector. For each ad space, an ad creative's attention-grabbing power depends on a correlation between the ad creative and the context layout parameters of the ad space. Since each context layout parameter has discrete states, the correlation between the ad creative and the context layout parameters cannot be expressed as an analytical formula, but a discrete state-to-value lookup table CL_LKP. For each ad creative, the context layout lookup table CL_LKP comprises an L-dimensional vector, of which each component is a lookup table operating on one context layout parameter,

CL_LKP(CL)={CL_LKPᵢ(CLᵢ)}, i=1, 2, . . . L.

The possible lookup values of each component of the CL_LKP vector are values between zero and one, which indicates the ad creative's relative attention-grabbing power with respect to a respective context layout parameter's certain state. For proper normalization, the sum of the maximum values of individual components in the CL_LKP is normalized to one, i.e.,

$${\sum }_{i = 1}^{KL} MAX ( {CL\_LKP}_{i} {( UD )}_{i} ) = 1 ,$$

unless the ad creative is not targeted toward any context layout parameters, in which case all components of the CL_LKP vector for all states are set to zero, or equivalently, the entire context layout targeting step is skipped. Context layout lookup tables CL_LKP may be determined by advertisers, ad designers, and/or ad experts. Alternatively, they may be continuously tuned based on real data.

### History Attention (HA) Vectors and the History Targeting (HT) Logic

As noted earlier, an ad creative may become less effective in attracting a user's attention if it has been shown to the same user too many times within a certain time span, as the user may become “fatigued” with the ad creative. Therefore, it may be preferred to circle among different ad creatives. This is often referred to as “frequency targeting.”

Ad creative history attention-targeting operates on a correlation between each ad creative and a plurality of ad creatives previously shown to a user immediately prior to the current online session. Ad creative history targeting tries to avoid showing the same ad creative too many times to the same user. For each user, ad creative history attention (HA) vectors are a set of AA vectors corresponding to the h ad creatives previously shown to the user, i.e.,

AA(j), j=1, 2, . . . h,

where h is a positive integer. The value of h is predetermined, and may be, for example 5. During ad serving, the HA vectors are used to disqualify any ad creative that has been shown h′ times out of the h times, where h′ is predetermined, and may be, for example 3. In other embodiments, other values of h and h′ may be used. The disqualification is implemented by defining a history targeting logic HT_logic. The HT_logic is a function of HA and the AA vector of the present ad creative, and is denoted as HT_logic(AA,HA). The HT_logic is assigned a large negative value if the present AA vector is similar to h′ or more of the h vectors in HA. According to one embodiment of the present invention, the value of HT_logic may be determined as the following. First, the absolute difference between the present AA vector and each of the h vectors in HA is computed,

$${diffAA}_{j} = {\sum }_{i = 1}^{N} \vert {HA}_{i} ( j ) - {AA}_{i} \vert \begin{matrix}, & j = 1 , 2 , … h .\end{matrix}$$

If h′ or more of the values diffAAⱼ are smaller than a predetermined threshold t, the HT_Logic is assigned a large negative value. Otherwise, the HT_Logic is assigned a value of 1.0. For proper normalization, the maximum value of HT_Logic is set to one. Other logic algorithms may be used according to other embodiments of the present invention.

### III. Attention Score

Table 1 summarizes the various attention parameters defined above. According to one embodiment, in real time ad serving, the system determines an attention score for each of a plurality of ad creatives corresponding to a same ad according to the following equation,

$$Attention = {c}_{UA} \cdot AA \cdot UA + {c}_{CA} \cdot AA \cdot CA + {c}_{G} \cdot AA \cdot G + {c}_{UD} \cdot {\sum }_{i = 1}^{K} {UD\_LKP}_{i} ( {UD}_{i} ) + {c}_{CL} \cdot {\sum }_{i = 1}^{L} {CL\_LKP}_{i} ( {CL}_{i} ) + {c}_{HT} \cdot HT\_Logic ( AA , HA ) ,$$

where c_{UA}, c_{CA}, c_{G}, c_{UD}, c_{CL}, and c_{HT} are predetermined coefficients for each term in the equation. These coefficients represent the relative weightings among the terms and may be used to fine-tune the algorithm. The symbol “•” between two vectors denotes the inner-product of the two vectors, e.g.,

$$AA \cdot UA = {\sum }_{i = 1}^{N} {AA}_{i} \cdot {UA}_{i} .$$

In one embodiment, the system computes the attention scores for a plurality of ad creatives in real time before presenting an ad impression. The system then selects an ad creative among the plurality of ad creatives to be used in the ad impression based on the attention scores. In one embodiment, the system selects an ad creative that has the highest attention score among the plurality of ad creatives. In other embodiments, the system selects an ad creative based on a probability function that is proportional to the attention scores or the nth power of the attention scores. In this case, the ad creatives that have negative attention scores should be first disqualified from consideration.

According to other embodiments, some attention parameters are pre-computed so that there will be less latency delay in ad serving. For example, the term AA•UA may be pre-computed for a million discrete classes of users. A million is a vast reduction from billions of all users. The term AA•CA may also be pre-computed for ad spaces in which the system may serve ads. The term AA•G can certainly be pre-computed. If there are any large negative values in UD_LKP, CL_LKP, HA_Logic that are excited by the corresponding UD, CL or (AA,HA), the ad creative may be dropped from computation.

### IV. Updating of User Attention (UA) Parameters

According to one embodiment, UA parameters for each user are continuously updated as each behavior instance (BI) of the user is captured by the system in an Infinite Impulse Response (IIR) fashion,

UA_{new}=(1−d·w)·UA_{old}+d·w·BI,

where d is an adjustable parameter of the IIR filter. The value of d indicates a percentage weighting of that particular behavior instance. For example, a value of 0.0001 means that particular behavior instance can infer about 0.01% of the user's subconscious interest. The value of d may depend on the type of behavior instance. For example, the value of d for a click instance may be greater than the value of d for a webpage visit instance. As an example, the value of d for a click instance may beset to 0.001, and the value of d for a webpage visit instance may be set to 0.00001. The values of d for various types of behavior instances may be determined by ad experts, advertisers, and/or ad designers. Alternatively, they may be determined by statistical analysis. w is a weight factor depending on the duration of time the user spends on that behavior instance. In one embodiment, w is determined according to the equation,

$$w = 1 - exp ( - \frac{t}{{t}_{0}} ) ,$$

where t is the duration of time the user spends on that particular behavior instance, and t₀ is the nominal duration of time average users spend on that behavior instance, e.g., 10 seconds. That is, if a person spends more than t₀ on a webpage, it means that the person is actually reading into the details of that webpage and therefore is truly interested in the webpage. Accordingly, this behavior instance is given more weight. The value t₀ may be different for different types of behavior instances. For example, the value of t₀ for a piece of music might be greater than that for a news article.

In other embodiments, UA parameters for each user may be updated in a batch fashion, such as once a day. Assuming that a user has a total of p behavior instances captured by the system in one day, where p is a positive integer, the UA parameters are updated as,

$${UA}_{new} = ( 1 - {\sum }_{j = 1}^{p} {d}_{j} \cdot {w}_{j} ) \cdot {UA}_{old} + {\sum }_{j = 1}^{p} {d}_{j} \cdot {w}_{j} \cdot {BI}_{j} .$$

Note that UA_{new} is still normalized to one.

### Long-Term and Short-Term UA Parameters

In one embodiment of the present invention, UA parameters are separated into a long-term UA parameters UA_L and a short-term UA parameters UA_S,

UA=g×UA_L+(1−g)×UA_S,

where g is a relative weighting factor and has a value between zero and one. As an example, UA_L may be determined by the user's behavior instances over a month, and UA_S may be determined by the user's behavior instances over a day. In alternative embodiments, UA_S may be determined by the user's behavior instances over a day, a week, or a month, and UA_L is continuously updated in an IIR fashion.

### V. Transformation of Subconscious Interest Categories

As the system evolves, the number of subconscious categories may need to be expanded from N to N+M. For a special case where the previous N categories stay unchanged, and the M new categories have no correlation to the previous N categories, an N-dimensional user attention vector UA_{N} may be transformed into an (N+M)-dimensional user attention vector UA_{N+M} as,

$${( {UA}_{N + M} )}_{i} = {( {UA}_{N} )}_{i} \cdot \frac{N}{N + M} , i = 1 , 2 , … {N \\ ( {UA}_{N + M} )}_{i} = \frac{1}{N + M} , i = N + 1 , … N + M .$$

Note that UA_{N+M} is still normalized.

In more general cases where N categories are changed to M categories, where M may be greater, equal, or smaller than N, and the definitions of the M categories may be different from the definitions of the N categories, a mapping matrix T may be used to transform an N-dimensional user attention vector UA_{N} into a M-dimensional user attention vector UA_{M},

UA_{M}=T×UA_{N},

where T is a M-row by N-column matrix. The symbol “×” denotes matrix multiplication. The mapping matrix T may be determined by experts. The sum of each column of the matrix T needs to be normalized to one so that UA_{M} stay normalized.

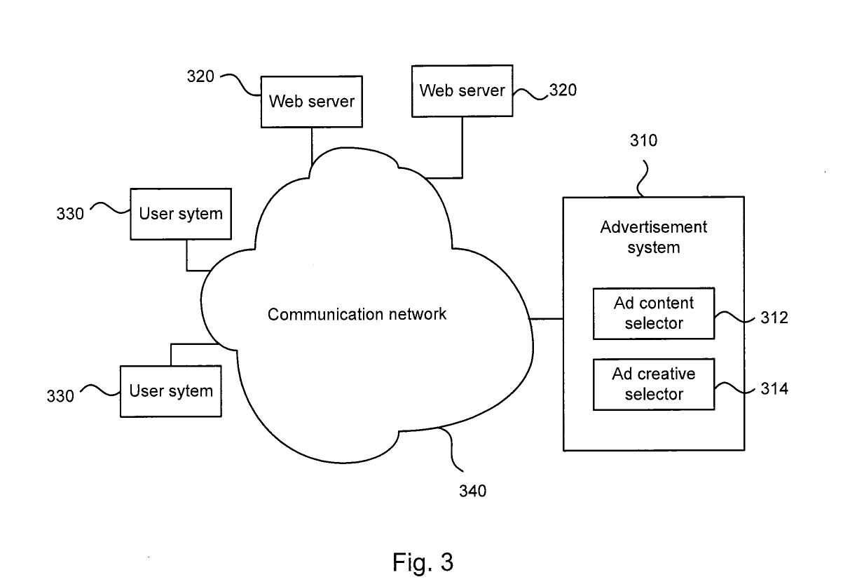

FIG. 3 shows a schematic diagram of a network environment that may incorporate an embodiment of the present invention. The advertisement system 310 is interconnected with one or more web servers 320 and one or more user systems 330 via a communication network 340. The advertisement system 310 comprises an ad content selector module 312 and an ad creative selector module 314. In one embodiment, the ad content selector module 312 selects an ad content to be served to a user according to an interest-targeting criteria and/or a credibility criteria. The ad creative selector module 314 selects an ad creative among a plurality of ad creatives corresponding to the selected ad content. The advertisement system 310 then serves the selected ad content with the selected ad creative as an ad impression to the user. It is understood that the ad content selector module 312 and the ad creative selector module 314 may be in separate modules or be in an integrated module.

Communication network 340 provides a mechanism for allowing communication between the various systems depicted in FIG. 3. Communication network 340 may be a local area network (LAN), a wide area network (WAN), a wireless network, an Intranet, the Internet, a private network, a public network, a switched network, or any other suitable communication network. Communication network 340 may comprise many interconnected computer systems and communication links. The communication links may be hardwire links, optical links, satellite or other wireless communications links, wave propagation links, or any other mechanisms for communication of information. Various communication protocols may be used to facilitate communication of information via the communication links, including TCP/IP, HTTP protocols, extensible markup language (XML), wireless application protocol (WAP), protocols under development by industry standard organizations, vendor-specific protocols, customized protocols, and others.

User systems 330 can be of various types including a personal computer, a portable computer, a workstation, a network computer, a mainframe, a smart phone, a personal digital assistant (PDA), a kiosk, or any other data processing system.

The advertisement system 310 may be embodied in the form of a computer system. Typical examples of a computer system include a general-purpose computer, a programmed microprocessor, a micro-controller, a peripheral integrated circuit element, and other devices or arrangements of devices that are capable of implementing the steps constituting the method of the present invention. The computer comprises a microprocessor, a communication bus, and a memory. The memory may include Random Access Memory (RAM) and Read Only Memory (ROM). Further, the computer system comprises a storage device, which can be a hard disk drive or a removable storage drive such as a floppy disk drive, an optical disk drive, and the like. The storage device can also be other similar means for loading computer programs or other instructions into the computer system.

The computer system executes a set of instructions that are stored in one or more storage elements, to process input data. The storage elements may also hold data or other information, as desired. The storage elements may be an information source or physical memory element present in the processing machine. The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program, or a portion of a program module. The software might also include modular programming in the form of object-oriented programming. Processing of input data by the processing machine may be in response to user commands, to the results of previous processing, or to a request made by another processing machine.

Aspects of the present invention can be stored as program code in hardware and/or software. Storage media and non-transitory computer readable media for containing code, or portions of code, for implementing aspects and embodiments of the present invention can include, for example and without limitation, magnetic cassettes, magnetic tapes, floppy disks, optical disks, CD-ROMs, digital versatile disk (DVD), magnetic-optical disks, read-only memories (ROMs), random access memories (RAMs), erasable programmable ROMs (EPROMs), and electrically erasable programmable ROMs (EEPROMs).

The foregoing description of the exemplary embodiments has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

TABLE 1

| Parameters | Parameter symbol | Property of |
|---|---|---|
| Ad creative attention | AA = {AAᵢ}, i = 1, 2, . . . N | Ad creative |
| parameters | | |
| User attention parameters | UA = {UAᵢ}, i = 1, 2, . . . N | User |
| Behavior instance | BI = {BIᵢ}, i = 1, 2, . . . N | Behavior |
| parameters | | instance |
| Content attention | CA = {CAᵢ}, i = 1, 2, . . . N | Ad space |
| parameters | | |
| Global parameters | G = {Gᵢ}, i = 1, 2, . . . N | |
| User demography | UD = {UDᵢ}, i = 1, 2, . . . K | User |
| parameters | | |
| User demography lookup | UD_LKP = {UD_LKPᵢ} | ad creative |
| table | i = 1, 2, . . . K | |
| Context layout parameters | CL = {CLᵢ}, i = 1, 2, . . . L | Ad space |
| Context layout lookup table | CL_LKP = {CL_LKPᵢ} | ad creative |
| | i = 1, 2, . . . L | |
| History attention | HA | User |
| parameters | | |
| History targeting logic | HT_Logic(AA, HA) | User and ad |
| | | creative |

What is claimed is:

1. A computer-implemented method of providing targeted online advertisement, the method comprising:
receiving a request for an ad to be provided to a user in an online session;
selecting, using a processor of a computer, an ad content corresponding to the request;
ranking, using a processor of the computer, a plurality of ad creatives corresponding to the selected ad content based at least in part on a correlation between each respective ad creative and a subconscious interest of the user;
selecting, using a processor of the computer, an ad creative among the plurality of ad creatives based at least in part on a result of the ranking; and
providing the selected ad content with the selected ad creative as an ad impression to be displayed to the user in response to the request.

2. The computer-implemented method of claim 1, wherein ranking a plurality of ad creatives comprises:
determining, using a processor of the computer, an attention score for each of the plurality of ad creatives based at least in part on a correlation between each respective ad creative and a subconscious interest of the user; and
ranking the plurality of ad creatives according to the attention scores.

3. The computer-implemented method of claim 2, wherein the subconscious interest of the user is determined by tracking online behavior instances of the user, and determining an attention score comprises determining a relative degree of relevance of each ad creative to the subconscious interest of the user.

4. The computer-implemented method of claim 2, wherein determining an attention score is further based at least in part on a correlation between each respective ad creative and demographic information of the user.

5. The computer-implemented method of claim 2, wherein determining an attention score is further based at least in part on a correlation between each respective ad creative and a content of the online session.

6. The computer-implemented method of claim 2, wherein determining an attention score is further based at least in part on a correlation between each respective ad creative and a context layout of the online session.

7. The computer-implemented method of claim 2, wherein determining an attention score is further based at least in part on a correlation between each respective ad creative and a plurality of ad creatives previously presented to the user immediately prior to the current online session.

8. A non-transitory computer-readable storage medium including instructions for providing targeted online advertisement, the instructions when executing causing at least one computer system to:
receive a request for an ad to be provided to a user;
select an ad content corresponding to the request;
rank a plurality of ad creatives corresponding to the selected ad content based at least in part on a correlation between each respective ad creative and a subconscious interest of the user;
select an ad creative among the plurality of ad creatives based at least in part on a result of the ranking; and
provide the selected ad content with the selected ad creative to be displayed to the user in response to the request.

9. The non-transitory computer-readable storage medium of claim 8, wherein ranking a plurality of ad creatives comprises:
determining an attention score for each of the plurality of ad creatives based at least in part on a correlation between each respective ad creative and a subconscious interest of the user; and
ranking the plurality of ad creatives according to the attention scores.

10. The non-transitory computer-readable storage medium of claim 9, wherein the subconscious interest of the user is determined by tracking online behavior instances of the user, and determining an attention score comprises determining a relative degree of relevance of each respective ad creative to the subconscious interest of the user.

11. The non-transitory computer-readable storage medium of claim 9, wherein determining an attention score is further based at least in part on a correlation between each respective ad creative and demographic information of the user.

12. The non-transitory computer-readable storage medium of claim 9, wherein determining an attention score is further based at least in part on a correlation between each respective ad creative and a content of the online session.

13. The non-transitory computer-readable storage medium of claim 9, wherein determining an attention score is further based at least in part on a correlation between each respective ad creative and a context layout of the online session.

14. The non-transitory computer-readable storage medium of claim 9, wherein determining an attention score is further based at least in part on a correlation between each respective ad creative and a plurality of ad creatives previously presented to the user immediately prior to the current online session.

15. A system for providing targeted online advertisement, comprising:
a processor; and at least one memory device storing instructions that, when executed by the processor, cause the system to:
receive a request for an ad to be provided to a user;
select an ad content corresponding to the request;
rank a plurality of ad creatives corresponding to the selected ad content based at least in part on a correlation between each respective ad creative and a subconscious interest of the user;
select an ad creative among the plurality of ad creatives based at least in part on a result of the ranking; and
provide the selected ad content with the selected ad creative to be displayed to the user in response to the request.

16. The system of claim 15, wherein ranking a plurality of ad creatives comprises:
determining an attention score for each of the plurality of ad creatives based at least in part on a correlation between each respective ad creative and a subconscious interest of the user; and
ranking the plurality of ad creatives according to the attention scores.

17. The system of claim 16, determining an attention score is further based at least in part on a correlation between each respective ad creative and demographic information of the user.

18. The system of claim 16, wherein determining an attention score is further based at least in part on a correlation between each respective ad creative and a content of the online session.

19. The system of claim 16, wherein determining an attention score is further based at least in part on a correlation between each respective ad creative and a context layout of the online session.

20. The system of claim 16, wherein determining an attention score is further based at least in part on a correlation between each respective ad creative and a plurality of ad creatives previously presented to the user immediately prior to the current online session.
